(19) United States
(12) Patent Application Publication
(10) Pub. No.: US 2017/0223545 A1
(43) Pub. Date: Aug. 3, 2017

(54) COMMUNICATION TERMINAL DEVICE, AND CONTROL METHOD THEREFOR

(71) Applicant: SHARP KABUSHIKI KAISHA, Sakai City, Osaka (JP)

(72) Inventors: Yoshitaka SUZUKI, Sakai City, Osaka (JP); Masafumi ARAMOTO, Sakai City, Osaka (JP); Hiroshi KATSURAGAWA, Sakai City, Osaka (JP); Natsuki YUASA, Sakai City, Osaka (JP); Hiroyuki KATATA, Sakai City, Osaka (JP)

(73) Assignee: SHARP KABUSHIKI KAISHA, Sakai City, Osaka (JP)

(21) Appl. No.: 15/500,350

(22) PCT Filed: Aug. 1, 2014
(86) PCT No.: PCT/JP2014/070393

§ 371 Date: Jan. 30, 2017

(51) Int. Cl. H04W 12/08; G06F 21/12

(52) U.S. Cl. CPC H04W 12/08; G06F 21/12

(57) ABSTRACT

Provided are a communication terminal device with which a user can easily recognize restriction contents when access is restricted, and a control method therefor. A communication terminal device configured to control access restriction according to access restriction information received includes: a restriction determination unit configured to determine whether or not access restriction is valid; and a control unit configured to, in a case that it is determined that the access restriction is valid, emphasize only a display of a service permitted to be used under the access restriction. This enables the user to easily recognize restriction contents when access is restricted.

### DESCRIPTION

Technical Field

The present invention relates to a communication terminal device that controls access restriction according to access restriction information received, a control method therefor, and a control program.

Background Art

Conventionally, a technique for restricting connection requests from terminals is known. In E-UTRAN (Evolved Universal Terrestrial Radio Access Network), a mobile station described in Patent Document 1 receives SIB2, performs a predetermined restriction process in the E-UTRAN based on information elements included in the SIB2, and performs a restriction process on an outgoing call of a CS call using the CSFB function, based on “ac-BarringForCSFB-r10” and “ac-BarringForMO-Data” among the above information elements.

Additionally, a method of restricting connections of voice communication is known. A base station described in Patent Document 2 receives a control signal from a user device via a bearer for the control signal set for each user device, irrespective of whether or not the user device can support the service specific access restriction method, and determines, according to a certain restriction rate, whether or not to restrict a voice signal of the user device that has transmitted the control signal.

Additionally, there is proposed a technique of receiving a signal regarding a restriction from a base station and simply displaying “under restriction” on the terminal side while such a restriction is imposed. For example, in a system described in Patent Document 3, while a dialing destination terminal is restricted, “under restriction” is displayed on its terminal, and calling operation is stopped. Additionally, in a system described in Patent Document 4, while congestion is occurring, information regarding a restriction is notified to a mobile terminal to be restricted. Further, in a system described in Patent Document 5, an access class restriction is displayed on a terminal.

### CITATION LIST

### Patent Document

Patent Document 1: Japanese Patent No. 4902771

Patent Document 2: Japanese Unexamined Patent Application, First Publication No. 2014-033385

Patent Document 3: Japanese Unexamined Patent Application, First Publication No. 2000-201379

Patent Document 4: Japanese Unexamined Patent Application, First Publication No. 2010-232811

Patent Document 5: Japanese Unexamined Patent Application, First Publication No. 2013-009404

### DISCLOSURE OF THE INVENTION

### Problems to be Solved by the Invention

As described above, in the conventional technique, the access restriction is displayed on the terminal, but the user cannot understand from such a display alone what is restricted. Such a terminal is not one made in deep pursuit of the ease of use, and it cannot be said that user friendliness is good.

The present invention has been made in view of such circumstances, and an object of the present invention is to provide a communication terminal device that enables a user to easily recognize restriction contents when access is restricted, a control method therefore, and a control program.

### Means for Solving the Problems

(1) In order to achieve the above object, the present invention takes the following measures. In other words, a communication terminal device of the present invention is configured to control access restriction according to access restriction information received. The communication terminal device includes: a restriction determination unit configured to determine whether or not access restriction is valid; and a control unit configured to, in a case that it is determined that the access restriction is valid, emphasize only a display of a service permitted to be used under the access restriction. This allows the user to easily recognize the restricted contents when the access is restricted.

(2) Additionally, in the communication terminal device of the present invention, the control unit is configured to display only the display of the service permitted to be used under the access restriction. Thereby, when access to a service is restricted, the user can easily recognize the permitted service.

(3) Further, in the communication terminal device of the present invention, the control unit is configured to, in a case that the access restriction restricts an application, display only an icon of an application permitted to be used under the access restriction. Thereby, when an application is restricted, the user can easily recognize the permitted application.

(4) Moreover, in the communication terminal device of the present invention, the control unit is configured to gray out a display of a service not permitted to be used under the access restriction. Thereby, when access to a service is restricted, the user can easily recognize the service not permitted.

(5) Additionally, in the communication terminal device of the present invention, the control unit is configured to, in a case that the access restriction restricts an application, gray out an icon of an application not permitted to be used under the access restriction. Thereby, when an application is restricted, the user can easily recognize the application not permitted.

(6) Further, in the communication terminal device of the present invention, the control unit is configured to, in a case that the access restriction restricts an application, deactivate an icon of an application not permitted to be used under the access restriction. Thereby, when an application is restricted, the user can easily recognize the application not permitted.

(7) Moreover, in the communication terminal device of the present invention, the control unit is configured to, in a case that the access restriction restricts an application, change a form of an icon of an application that behaves differently under the access restriction. Thereby, when an application is restricted, the user can easily recognize the application that behaves differently under the access restriction.

(8) Additionally, in the communication terminal device of the present invention, the restriction determination unit is configured to determine whether or not the access restriction information received indicates a restriction during disaster. Thereby, it is possible to determine from the access restriction information whether to perform the restriction during disaster.

(9) Further, in the communication terminal device of the present invention, the restriction determination unit is configured to determine whether or not the access restriction information received includes information indicating that it is during disaster, thus determining whether or not the access restriction information received indicates the restriction during disaster. Thereby, it can be determined from the access restriction information whether or not it is during disaster.

(10) Moreover, in the communication terminal device of the present invention, the restriction determination unit is configured to determine whether or not the access restriction information received includes information indicating permission to use a disaster application, thus determining whether or not the access restriction information received indicates the restriction during disaster. Thereby, it can be determined from the access restriction information whether or not it is during disaster.

(11) Additionally, in the communication terminal device of the present invention, the control unit is configured to, in a case that it is determined that the access restriction information received indicates the restriction during disaster, change a desktop display to a desktop display for disaster. Thereby, convenience of the user can be improved when access is restricted.

(12) Further, in the communication terminal device of the present invention, when the control unit is configured to transition to a power saving mode in a case that it is determined that the access restriction is valid. Thereby, power consumption can be reduced during access restriction where use of the terminal is restricted.

(13) Moreover, in the communication terminal device of the present invention, the control unit is configured to transition to a power saving mode in a case that the access restriction is determined to be valid, and a user has made a setting that the power saving mode is available when the access restriction is valid. Thereby, power consumption can be reduced during access restriction where use of the terminal is restricted.

(14) Additionally, in the communication terminal device of the present invention, the control unit is configured to save a power of a backlight as the power saving mode. This makes it possible to reduce the power consumption especially for the backlight power source during the access restriction.

(15) Further, in the communication terminal device of the present invention, the control unit is configured to, in a case that it is determined that the access restriction is valid, turn off the power of the backlight in a shorter time than in a case that the access restriction is not valid. This makes it possible to reduce the power consumption especially for the backlight power source during the access restriction.

(16) Moreover, in the communication terminal device of the present invention, the control unit is configured to suspend the power saving mode in a case that it is determined that the access restriction is no longer valid. Thereby, since the cell search is suspended during the access restriction, power consumption can be reduced.

(17) Additionally, in the communication terminal device of the present invention, the control unit is configured to terminate the power saving mode in a case that it is determined that the access restriction is no longer valid. Thereby, when the access restriction is released, the power saving mode can be automatically terminated.

(18) Further, in the communication terminal device of the present invention, the control unit is configured to notify a user of release of the access restriction in a case that it is determined that the access restriction is no longer valid. Thereby, the user can recognize that the access restriction has been released.

(19) Further, in the communication terminal device of the present invention, wherein the control unit is configured to notify a user of release of the access restriction in a case that it is determined that the access restriction is no longer valid, and the user has made a setting that a notification is to be given to the user when the access restriction is released. Thereby, according to the setting, the user can recognize that the access restriction has been released.

(20) Moreover, in the communication terminal device of the present invention, the control unit is configured to, according to a setting, delay a timing of notifying of the release of the access restriction. Thereby, it is possible to disperse an increase in communication traffic due to the release of the access restriction.

(21) Additionally, in the communication terminal device of the present invention, the control unit is configured to, in a case that the access restriction is ACB restriction, emphasizes that a wireless LAN connection is available. Thereby, the user can recognize that a wireless LAN connection is available under the ACB restriction, and the convenience of the user is improved.

(22) Further, a control method of the present invention is a method for a communication terminal device configured to control access restriction according to access restriction information received. The control method includes: a step of determining whether or not access restriction is valid; and a step of, in a case that it is determined that the access restriction is valid, emphasizing only a display of a service permitted to be used under the access restriction. This allows the user to easily recognize the restricted contents when the access is restricted.

(23) Moreover, a control program of the present invention is a control program for a communication terminal device configured to control access restriction according to access restriction information received. The control program causes a computer to perform a series of processes including: a process of determining whether or not access restriction is valid; and a process of, in a case that it is determined that the access restriction is valid, emphasizing only a display of a service permitted to be used under the access restriction.

### Effects of the Invention

According to the present invention, the user can easily recognize restriction contents when access is restricted.

### BRIEF DESCRIPTION OF THE DRAWINGS

FIG. 1 is a schematic diagram of a communication system of the present invention.

FIG. 2 is a block diagram showing a communication terminal device of the present invention.

FIG. 3 is a flowchart showing operation of the communication terminal device of the present invention.

FIG. 4 is a flowchart showing operation of the communication terminal device of the present invention.

FIG. 5 is a diagram showing an example of a standby screen at a normal time.

FIG. 6 is a diagram showing an example of a standby screen during restriction.

FIG. 7 is a diagram showing an example of a standby screen during restriction.

FIG. 8 is a diagram showing an example of a standby screen during restriction.

FIG. 9 is a diagram showing an example of a standby screen during restriction.

FIG. 10 is a diagram showing an example of a standby screen during restriction.

FIG. 11 is a diagram showing an example of a standby screen during restriction.

FIG. 12 is a diagram showing an example of a standby screen during restriction.

FIG. 13 is a diagram showing an example of a standby screen during restriction.

### MODE FOR CARRYING OUT THE INVENTION

Hereinafter, embodiments of the present invention will be described with reference to the drawings.

### Configuration of Communication System

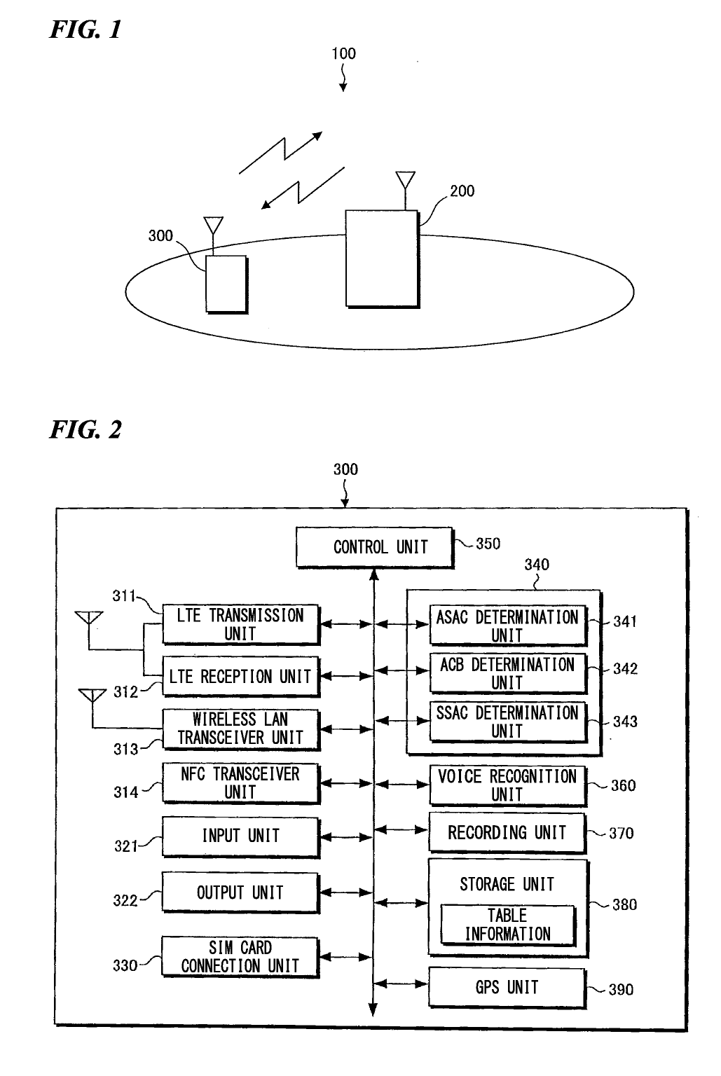

FIG. 1 is a schematic diagram of a communication system 100. The communication system 100 includes a base station device 200 and a communication terminal device 300. The base station device 200 and the communication terminal device 300 perform wireless communication. During access restriction, the base station device 200 transmits access restriction information as broadcast information, while the communication terminal device 300 receives the transmitted access restriction information. Then, access restriction is controlled based on the information. Here, the communication terminal device 300 is, for example, a smartphone, a cellular phone, a PDA terminal, a tablet terminal, a sensor device having a communication function, a home electric device, a vending machine, or the like.

### Configuration of Communication Terminal Device

FIG. 2 is a block diagram showing the communication terminal device 300. The communication terminal device 300 includes an LTE transmission unit 311, an LTE reception unit 312, a wireless LAN transceiver unit 313, an NFC transceiver unit 314, an input unit 321, an output unit 322, an SIM card connection unit 330, a restriction determination unit 340, a control unit 350, a voice recognition unit 360, a recording unit 370, a storage unit 380, and a GPS unit 390.

The LTE transmission unit 311 and the LTE reception unit 312 transmit and receive data to and from the base station device 200 according to the LTE (Long Term Evolution) scheme. The LTE reception unit 312 receives access restriction information transmitted from the base station device 200. Here, these transmission unit and reception unit do not necessarily operate according to the LTE scheme.

The wireless LAN transceiver unit 313 communicates with an external server via a wireless LAN access point and a network using a wireless LAN antenna. A wireless LAN access point may be a wireless LAN router or the like installed at a public facility, home, or the like.

The NFC transceiver unit 314 performs contactless wireless communication. In that case, it receives an electromagnetic wave emitted within a predetermined distance (for example, a short distance of tens of centimeters), activates a contactless IC tag with the electric energy of the electromagnetic wave as a power source, carries on the electromagnetic wave, and thus transmits from the contactless IC tag, NFC identification information set to the contactless IC tag. Then, the transmitted electromagnetic wave is received by an NFC reader, and the NFC identification information is read from the received electromagnetic wave.

The input unit 321 receives a message inputted by a user though, for example, a touch panel, an operation key, or the like. The output unit 322 displays a graphical user interface (GUI) for operation and displays a message according to the operation.

The SIM card connection unit 330 stores the SIM card (Subscriber Identity Module Card) in the communication terminal device and is connected to the SIM card. Signals are transmitted and received via connection terminals to and from a conductor plate of a SIM chip provided so as to be exposed on a surface of the SIM card.

The SIM card is a portable storage medium that stores calling contract information and personal information regarding subscribers and includes an SIM chip and a radio circuit. A unique number is given to the SIM card, and this unique number is linked with the telephone number, thus enabling communication. Here, instead of the SIM card, a configuration using eSIM (Embedded SIM) may be adopted in which a nonvolatile rewritable memory chip or the like for storing the calling contract information and personal information regarding the subscribers is directly installed in the communication terminal device.

The restriction determination unit 340 determines based on the received restriction information whether or not the access restriction is valid. The restriction determination unit 340 includes an ASAC determination unit 341, an ACB determination unit 342, and an SSAC determination unit 343.

The ASAC determination unit 341 determines, based on ASAC (Application and Service Access restriction) information received, whether or not the access restriction regarding an application on the communication terminal is valid. Specifically, it is determined whether ASAC information is included in the received broadcast signal. The ASAC information is information which is transmitted from the base station to the communication terminal device and which broadcasts access restriction on an application. An example of the ASAC information will be described later.

The ASAC determination unit 341 can determine whether or not the received ASAC information indicates a restriction during disaster. For example, the ASAC determination unit 341 can determine whether or not the received access restriction information includes information indicating permission to use a disaster application, thus determining whether or not the received access restriction information indicates a restriction during disaster. As a result, it can be determined from the access restriction information whether or not it is during disaster.

The ASAC determination unit 341 may also determine whether or not the received access restriction information indicates a restriction during disaster, based on whether or not the received access restriction information includes information indicating that it is during disaster.

The ACB determination unit 342 determines from the received broadcast signal whether or not an access class of the communication terminal device 300 itself is subject to the restriction. If the access class of the communication terminal device 300 is subject to the restriction, the ACB determination unit 342 generates a random number, and determines whether or not communication is enabled according to a result of comparison between the random number and a threshold value. The access class is predetermined for all communication terminal devices 300 before communication is started, and communication terminal devices 300 are classified for each access class. The base station device 200 determines an access class to be restricted and broadcasts the access class by a broadcast signal or broadcast information to the communication terminal device 300 present in the cell.

The SSAC determination unit 343 determines whether or not a service specific access restriction is valid. The service specific access restriction (SSAC) is notified by the broadcast signal. When transitioning from the standby idle state to the in-communication active state to start communication, it is determined whether or not the SSAC restriction is activated from the received broadcast signal. In a case where the SSAC restriction has been activated, when trying to use a restricted service, the communication terminal device 300 generates a random number and determines whether or not communication is enabled according to a result of comparison between the random number and a threshold value. If communication is enabled as a result of the determination, an RRC (Radio Resource Control) connection is set, and communication is started.

If the access restriction is determined to be valid, the control unit 350 disables use of communication or a service to be restricted, activation of an application to be restricted, or communication by the application. Further, if it is determined that the access restriction is valid, the control unit 350 can change a display of an icon on the display screen or set the state of the communication terminal device 300 to a power saving mode. Here, the use of an application is a form of a service.

For example, the control unit 350 can emphasize only the display of the service permitted to be used under the access restriction. As a result, the user can recognize the restricted contents when access is restricted. Details of changes in icon display and power saving mode will be described later.

The voice recognition unit 360 compares a voice captured by a microphone with a voice pattern stored in the storage unit and outputs a result indicating whether or not they match. At that time, voice recognition can be performed with reference to prosodic information, phoneme standard patterns, other parameters, dictionaries recording vocabularies, and the like.

The recording unit 370 records a voice captured by the microphone. The storage unit 380 stores a table for specifying individual applications to be restricted with respect to reasons for restrictions, or a table for specifying individual applications with respect to information specifying the types of applications to be restricted. Additionally, it stores a message inputted by the user. Further, when the voice recognition function is used, pre-registered voice patterns are stored therein.

The GPS unit 390 can receive a carrier wave from a plurality of GPS (Global Positioning System) satellites, process information related to the position included in the carrier wave, and calculate the position (longitude, latitude, altitude) of the communication terminal device 300.

### Example of ASAC Information

Examples of the ASAC information included in the broadcast information are as follows.

### (1) Examples of Information to Be Transmitted

There is a case where the ASAC information is information indicating a restriction reason, such as a disaster, an event, or the like. In this case, by using a database stored in the storage unit 380 of the communication terminal device 300, it is possible to specify individual applications (hereinafter also referred to as applications) to be restricted. The ASAC information may be information for specifying a type of application. Additionally, the ASAC information may be information for specifying an individual application. Here, as the restriction by an event, for example, there may be cases where functions other than the function for participating in activities at the concert venue are restricted.

### (2) Examples of Restriction Methods

The ASAC information can be information that generally restricts no application and broadcasts only an application to be restricted. Additionally, ASAC information may be information that generally restricts all applications and broadcasts applications not to be restricted.

### (3) Example of Operation to Be Restricted

The ASAC information may be information that restricts activation of an application, or information that restricts communication of an application.

### First Operation Example (ASAC information specifies restriction reason, type of application)

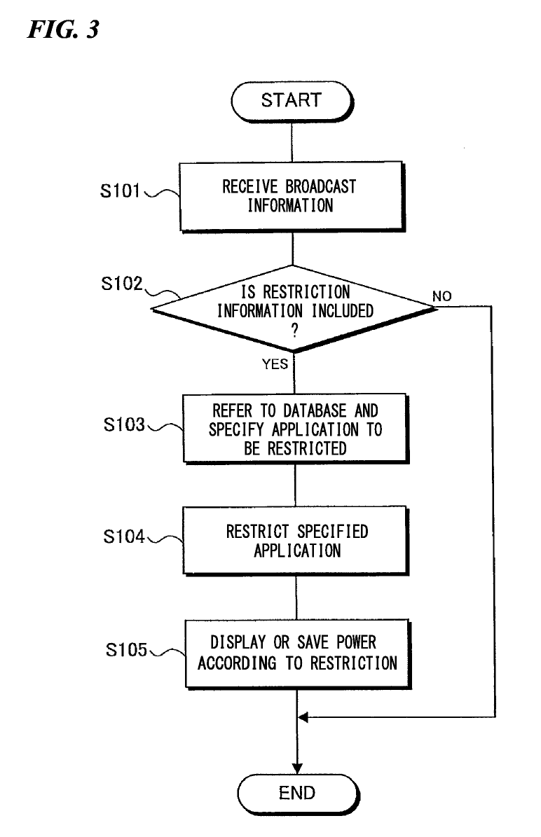

The operation of the communication terminal device 300 configured as described above will be described below. First, an explanation is given with respect to the operation in a case where the restriction information shows only a reason for restriction or a type of application to be restricted, and the communication terminal device 300 stores a correspondence relationship between the reason or type and an individual application. FIG. 3 is a flowchart showing the operation of the communication terminal device 300.

First, the communication terminal device 300 receives broadcast information from the base station device 200 (step S101). Then, it is determined whether or not the broadcast information includes the restriction information (step S102). If the broadcast information does not include the restriction information, the processing ends as it is.

If the broadcast information includes the restriction information, the database is referred to, and an application corresponding to the reason for restriction or the type of application is retrieved from the table, thereby specifying the application to be restricted (step S103). Then, the specified application is restricted (step S104). Activation of the application may be restricted, or communication after the activation of the application may be restricted (the same applies below). Next, screen display and power saving processing according to the restriction are performed (step S105), and the processing ends. Details of screen display and power saving processing will be described later.

### Second Operation Example (ASAC information specifies individual application)

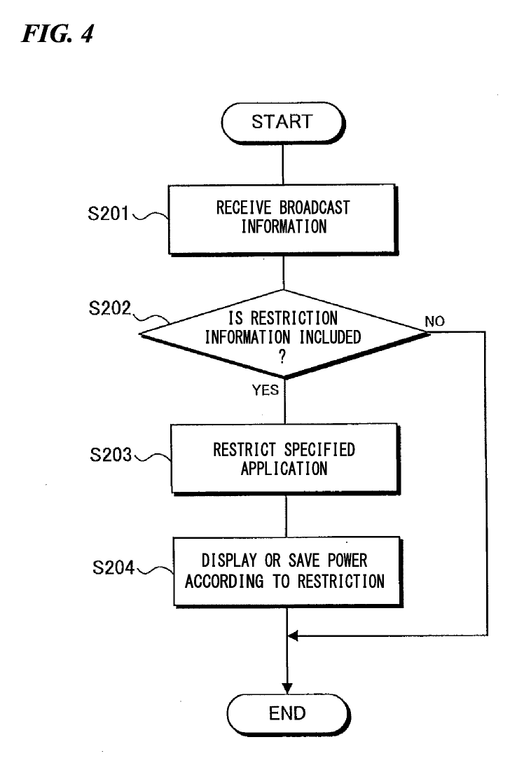

Next, the operation in a case where the restriction information indicates identification information of individual applications to be restricted will be described. FIG. 4 is a flowchart showing the operation of the communication terminal device 300.

First, the communication terminal device 300 receives broadcast information from the base station device 200 (step S201). Then, it is determined whether or not the broadcast information includes restriction information (step S202). If the broadcast information does not include the restriction information, the processing ends as it is.

If the broadcast information includes the restriction information, an application to be restricted is specified based on the restriction information, and the specified application is restricted (step S203). Next, screen display and power saving processing according to the restriction are performed (step S204), and the processing ends. Details of screen display and power saving processing will be described later.

### Example of Screen Display At Normal Time

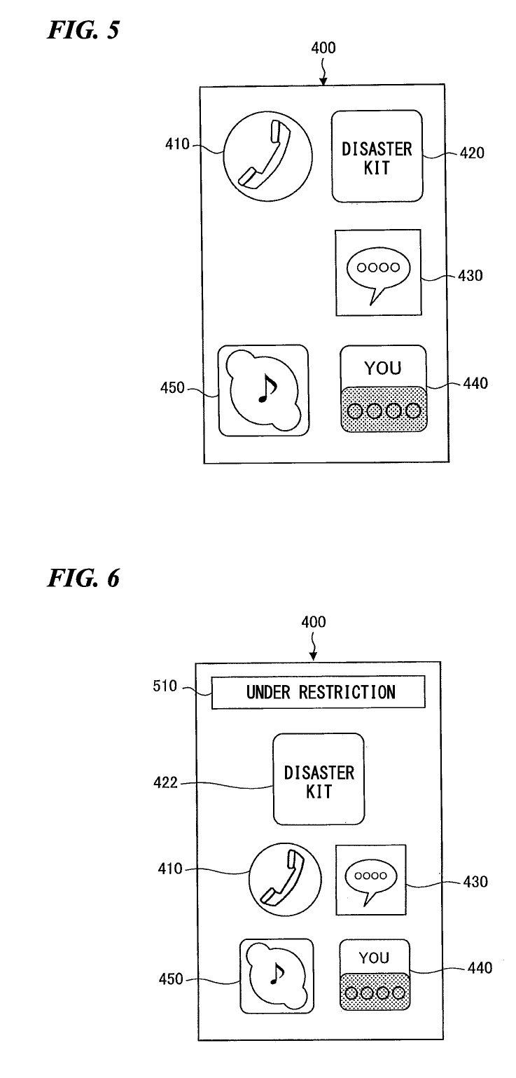

First, an example of a screen display at the normal time will be described. FIG. 5 is a diagram showing a standby (desktop) screen 400 of the communication terminal device 300 at the normal time. In the screen display example shown in FIG. 5, on the standby screen 400, a call start icon 410, a disaster kit activation icon 420, an IM activation icon 430, a video sharing service activation icon 440, and an Internet phone activation icon 450 are displayed in substantially the same size, in a casual arrangement.

The disaster kit activation icon 420 is an icon for activating an application of the disaster kit. Activation of the disaster kit application makes it possible to use disaster services, such as transmission of a voice message using packet communication instead of voice communication, registration and confirmation of safety information on a disaster message board, reception of emergency breaking news, and the like.

The IM activation icon 430 is an icon for activating an instant messenger application. Instant messenger is an application that realizes real-time communication through a computer network (mainly the Internet) and has functions, such as Internet phone and text chat. If users install applications mutually, it is possible to make voice calls and chat including group calls.

The video sharing service activation icon 440 is an icon for activating an application of video sharing service. Video sharing service is a service provided for, for example, sharing and enjoying interesting video shot/created by individuals, and most video formats are uploadable.

The Internet phone activation icon 450 is an icon for activating an Internet phone application. The Internet phone application enables users to make free calls using a head microphone set (or earphone). A messenger, a file transmission function, a screen sharing function, and the like, are also installed.

In the communication terminal device 300, the standby screen is normally displayed as shown in FIG. 5. In a case where the broadcast information includes restriction information, however, some services or applications are restricted and the standby screen is changed.

### Example of Screen Display and Power Saving Mode During Restriction (Change of Arrangement of Icons, Display of “Under Restriction”)

FIG. 6 is a diagram showing a standby screen during restriction. In the example shown in FIG. 6, an image 510 described as “under restriction” is displayed at the upper end of the screen. Further, the arrangement of the respective icons is changed, and as an icon of an available application, the disaster kit activation icon 422 is arranged upper on the screen than the positions of the other icons and is displayed large.

### Display Only Permitted Services or Applications

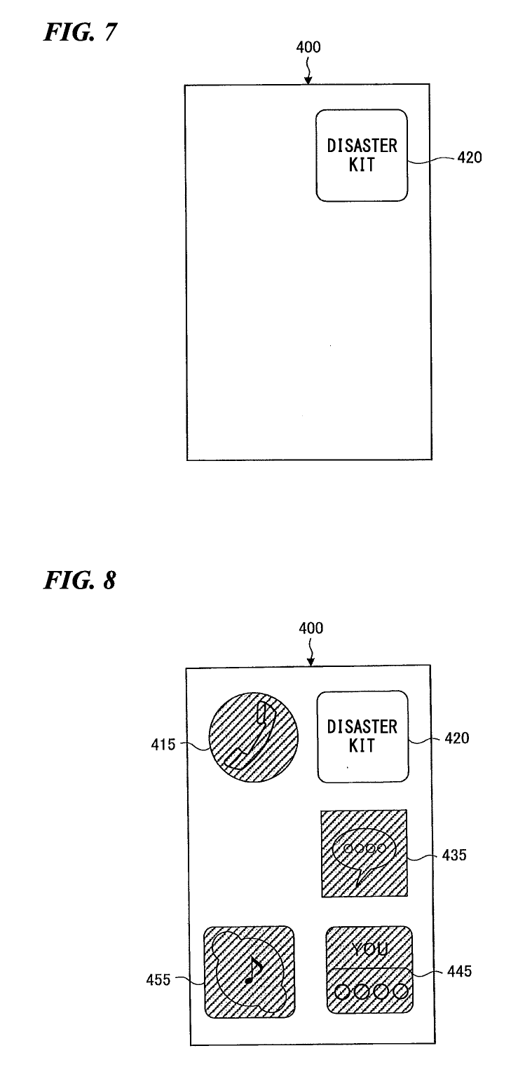

FIG. 7 is a diagram showing an example of a standby screen during restriction. The communication terminal device 300 can display only a display of a service or application permitted to be used under the access restriction. As a result, when the access to a service is restricted, the user can easily recognize the permitted service or application. In the example shown in FIG. 7, only the disaster kit activation icon 420 is displayed on the standby screen, as an icon of the application permitted to be activated or communicated even during the access restriction.

### Gray Display of Unpermitted Application

FIG. 8 is a diagram showing an example of a standby screen during restriction. The communication terminal device 300 may gray out a display of a service or application not permitted to be used under the access restriction. As a result, when the access to a service or application is restricted, the user can easily recognize the unpermitted service. Unpermitted applications, including the gray display, can be displayed less noticeably than allowed applications.

In the example shown in FIG. 8, a call start icon 415, an IM start icon 435, a video sharing service activation icon 445, and an Internet phone start icon 455 are displayed in gray on the screen 400 as icons of the services or applications not permitted to be used. On the other hand, the use of the disaster kit application is permitted even during restriction, and the disaster kit activation icon 420 is displayed as usual.

### Display in Different Colors of Unpermitted Applications

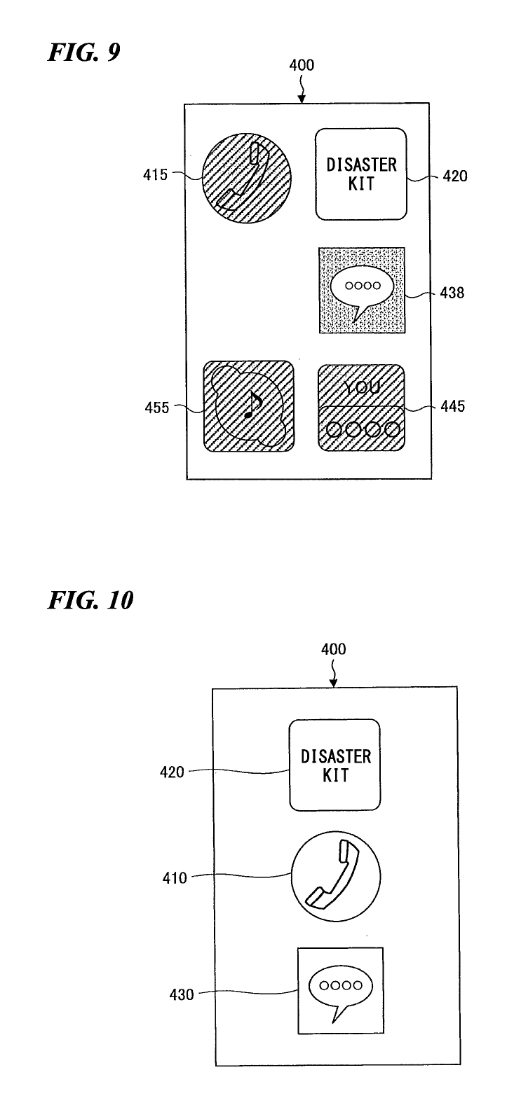

FIG. 9 is a diagram showing an example of a standby screen during restriction. If a behavior of an application changes due to a restriction, the color of the icon thereof may be changed. For example, in a case where the instant messenger and the carrier's disaster message board work together during disaster, the icons of the instant messenger can be changed in color. In the example shown in FIG. 9, the call start icon 415, the video sharing service start icon 445, and the Internet phone start icon 455 are grayed out, while the disaster kit activation icon 420 is displayed as usual, and the IM start icon 438 is displayed in a color different from normal.

### Deactivation of Icons of Unpermitted Applications

In a case where an access restriction restricts an application, the communication terminal device 300 may deactivate an icon of the application not permitted to be used under the access restriction. Deactivation means that the application does not start even if the icon is selected by touch or click operation. As a result, when an application is restricted, the user can easily recognize the unpermitted application.

### Screen Structure According to Restriction Reason

FIG. 10 is a diagram showing an example of a standby screen during restriction. In a case where an access restriction restricts an application, the communication terminal device 300 changes a form of an icon of the application that behaves differently under the access restriction. Thus, when an application is restricted, the user can easily recognize the application that behaves differently under the access restriction. In the example shown in FIG. 10, the disaster kit activation icon 427, the call start icon 417, and the IM activation icon 437 are arranged at the center in the standby screen 400 and are displayed larger than the normal icon. Here, the form of the icon includes the shape, pattern, or color of the icon, or a combination thereof

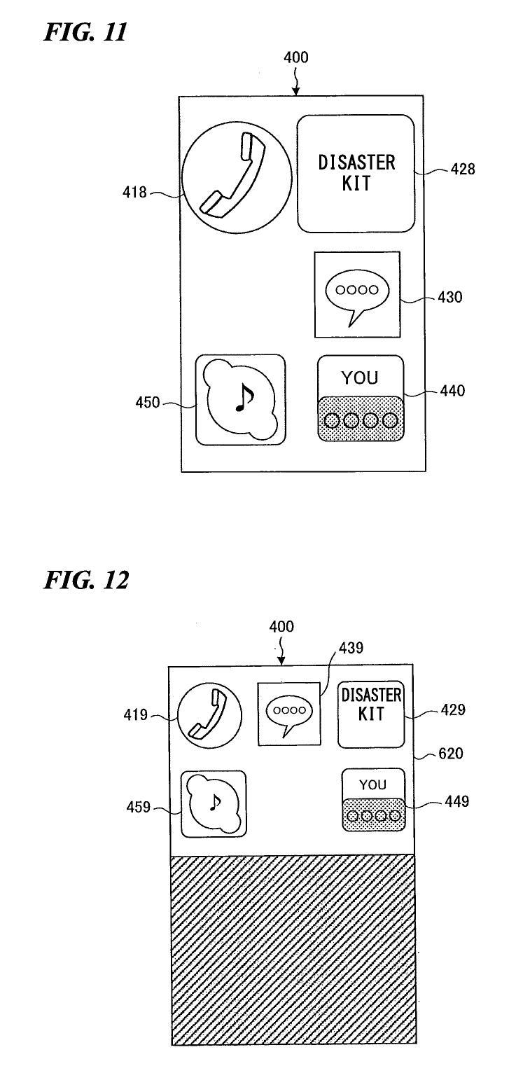

FIG. 11 is a diagram showing an example of a standby screen during restriction. In a case where it is determined that the received access restriction information indicates a restriction during disaster, the communication terminal device 300 may change the desktop display to a desktop display for disaster use. As a result, convenience of the user can be improved when there is an access restriction. In the example shown in FIG. 11, the arrangement of icons is the same as that in the normal case, but the call start icon 418 and the disaster kit activation icon 428 are displayed larger as icons of services or applications permitted to be used even during disaster.

### Transition to Power Saving Mode

In the above example, only the display on the standby screen 400 is changed during restriction, but the communication terminal device 300 may transition to the power saving mode when the access restriction is determined to be valid. As a result, power consumption can be reduced during access restriction where use of the terminal is restricted.

The communication terminal device 300 can also transition to the power saving mode when the access restriction is determined to be valid, and the user has made a setting that permits the transition to the power saving mode when the access restriction is valid. As a result, power consumption can be reduced during access restriction where use of the terminal is restricted.

In a case where it is determined that the access restriction is valid, the communication terminal device 300 can also turn off the power of a backlight in a shorter time than in a case where the access restriction is not valid. This makes it possible to reduce the power consumption especially for the backlight power source during the access restriction.

### Power Saving of Backlight Power Supply

FIG. 12 is a diagram showing a standby screen during restriction. The communication terminal device 300 may save the power of the backlight as a power saving mode. For example, as shown in FIG. 12, a display area and a backlight irradiation area are narrowed to save power. This makes it possible to reduce the power consumption especially for the backlight power source during the access restriction.

In the example shown in FIG. 12, each of a call start icon 419, a disaster kit activation icon 429, an IM activation icon 439, a video sharing service activation icon 449, and an Internet phone activation icon 459 is displayed small.

### Cell Search Limitation

The control unit 350 may decrease the frequency of, or suspend, cell search for achieving synchronization with the base station device 200, as the power saving mode. This makes it possible to reduce power consumption required for cell search during access restriction.

### Operation at Release of Restriction

The communication terminal device 300 terminates the power saving mode in a case where it is determined that the restriction information is not included in the broadcast information, and the access restriction is no longer valid. As a result, when the access restriction is released, the power saving mode can be automatically terminated.

In a case where it is determined that the access restriction is no longer valid, the communication terminal device 300 notifies the user of the release of the access restriction. As a result, the user can recognize that the access restriction has been released.

In a case where it is determined that the access restriction is no longer valid, and the user has made the setting that a notification is to be given to the user when the access restriction is released, the communication terminal device 300 may notify the user of the release of the access restriction. Thus, according to the setting, the user can recognize that the access restriction has been released.

The communication terminal device 300 may delay the timing of notifying of the release of the access restriction according to the setting. As a result, it is possible to prevent the communication traffic from increasing due to concentration of the communication after the access restriction is released, and to disperse the communication traffic.

### ACB Restriction

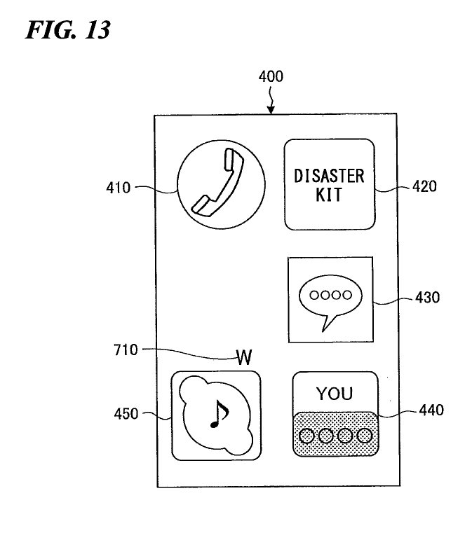

FIG. 13 is a diagram showing a standby screen during restriction. When the access restriction is ACB restriction, the communication terminal device 300 can also highlight the fact that wireless LAN connection is available. In the example shown in FIG. 13, a character 710 of “W” is displayed beside the Internet phone activation icon, thus indicating that wireless LAN connection is available. As a result, the user can recognize that wireless LAN connection is available during the ACB restriction, thus improving the convenience of the user.

### DESCRIPTION OF REFERENCE NUMERALS

100 communication system
200 base station device
300 communication terminal device
311 LTE transmission unit
312 LTE reception unit
313 wireless LAN transceiver unit
314 NFC transceiver unit
321 input unit
322 output unit
330 SIM card connection unit
340 restriction determination unit
341 ASAC determination unit
342 ACB determination unit
343 SSAC determination unit
350 control unit
360 voice recognition unit
370 recording unit
380 storage unit
390 GPS unit
400 standby screen (desktop screen)
410, 415, 417, 418, 419 call start icon
420, 422, 427, 428, 429 disaster Kit activation icon
430, 435, 437, 438, 439 IM activation icon
440, 445, 449 video sharing service activation icon
450, 455, 459 Internet phone activation icon
510 image
620 display screen
710 character

1. A communication terminal device configured to communicate with a base station, the communication terminal device comprising:
a reception unit configured to receive broadcast information;
an ASAC determination unit configured to determine whether or not access restriction is valid, based on whether or an ASAC (Application and Service Access Control information is included in the broadcast information; and
a control unit configured to, in a case that the ASAC determination unit determines that the access restriction is valid, emphasize only a display of a service permitted to be used under the access restriction.

2. The communication terminal device according to claim 1, wherein the control unit is configured to display only the display of the service permitted to be used under the access restriction.

3. The communication terminal device according to claim 2, wherein the control unit is configured to, in a case that the access restriction restricts an application, display only an icon of an application permitted to be used under the access restriction.

4. The communication terminal device according to claim 1, wherein the control unit is configured to gray out a display of a service not permitted to be used under the access restriction.

5. The communication terminal device according to claim 4, wherein the control unit is configured to, in a case that the access restriction restricts an application, gray out an icon of an application not permitted to be used under the access restriction.

6. The communication terminal device according to claim 1, wherein the control unit is configured to, in a case that the access restriction restricts an application, deactivate an icon of an application not permitted to be used under the access restriction.

7. The communication terminal device according to claim 1, wherein the control unit is configured to, in a case that the access restriction restricts an application, change a form of an icon of an application that behaves differently under the access restriction.

8. The communication terminal device according to claim 1, wherein the ASAC determination unit is configured to determine whether or not the ASAC information received indicates a restriction during disaster.

9. The communication terminal device according to claim 8, wherein the ASAC determination unit is configured to determine whether or not the ASAC information received includes information indicating that it is during disaster, thus determining whether or not the ASAC information received indicates the restriction during disaster.

10. The communication terminal device according to claim 8, wherein the ASAC determination unit is configured to determine whether or not the ASAC information received includes information indicating permission to use a disaster application, thus determining whether or not the ASAC information received indicates the restriction during disaster.

11. The communication terminal device according to claim 8, wherein the control unit is configured to, in a case that it is determined that the ASAC information received indicates the restriction during disaster, change a desktop display to a desktop display for disaster.

12. The communication terminal device according to Claim 1, wherein the control unit is configured to transition to a power saving mode in a case that it is determined that the access restriction is valid.

13. The communication terminal device according to claim 1, wherein the control unit is configured to transition to a power saving mode in a case that the access restriction is determined to be valid, and a user has made a setting that the power saving mode is available when the access restriction is valid.

14. The communication terminal device according to claim 12, wherein the control unit is configured to save a power of a backlight as the power saving mode.

15. The communication terminal device according to claim 14, wherein the control unit is configured to, in a case that it is determined that the access restriction is valid, turn off the power of the backlight in a shorter time than in a case that the access restriction is not valid

16. The communication terminal device according to claim 12, wherein the control unit is configured to, as the power saving mode, decrease a frequency of cell search for achieving synchronization with the base station device.

17. The communication terminal device according to claim 12, wherein the control unit is configured to terminate the power saving mode in a case that it is determined that the access restriction is no longer valid.

18. The communication terminal device according to claim 1, wherein the control unit is configured to notify a user of release of the access restriction in a case that it is determined that the access restriction is no longer valid.

19. The communication terminal device according to claim 1, wherein the control unit is configured to notify a user of release of the access restriction in a case that it is determined that the access restriction is no longer valid, and the user has made a setting that a notification is to be given to the user when the access restriction is released.

20. The communication terminal device according to claim 18, wherein the control unit is configured to, according to a setting, delay a timing of notifying of the release of the access restriction.

21. (canceled)

22. A control method for a communication terminal device configured with a base station, the control method comprising:
receiving broadcast information,
determining whether or not access restriction is valid, based on whether or not ASAC (Application and Service Access Control) information is included in the broadcast information; and
in a case that the ASAC determination unit determines the access restriction is valid, emphasizing only a display of a service permitted to be used under the access restriction.

23. (canceled)
